(19) United States
(12) Patent Application Publication
(10) Pub. No.: US 2009/0063338 A1
(43) Pub. Date: Mar. 5, 2009

(54) Method and System for Making Automated Purchases

(76) Inventor: Martin-Luc Archambault, Montreal (CA)

Correspondence Address: HULSEY IP INTELLECTUAL PROPERTY LAWYERS, P.C., 919 Congress Avenue, Suite 919, AUSTIN, TX, 78701, US

(21) Appl. No.: 12/134,031

(22) Filed: Jun. 5, 2008

Related U.S. Application Data
(60) Provisional application No. 60/942,062, filed on Jun. 5, 2007.

(51) Int. Cl. G06Q 30/00

(52) U.S. Cl. 705/40; 705/26

(57) ABSTRACT

A method and system for placing an order for an item which allows a purchaser to search for an item across multiple merchants, including merchants without a pre-existing agreement to be included in the search, returns a list of merchants with the desired item, enables the user to sort the list according to several criteria (including: price; price and shipping; price, shipping, tax, and fees; shipping time; and country of merchant) and enables the purchaser to purchase the item from any of the listed merchants with a single action even if the purchaser did not have an account with the chosen merchant.

### RELATED APPLICATIONS

This application claims the benefit of priority to U.S. Provisional Application No. 60/942,062 filed Jun. 5, 2007 entitled, “METHOD AND SYSTEM FOR MAKING AUTOMATED PURCHASES” by inventor Martin-Luc Archambault, and is incorporated herein by reference.

### FIELD OF THE INVENTION

This invention pertains to and relates to a computer method and system for placing an order and, more particularly, to a method and system for ordering items over the Internet.

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The World Wide Web is especially conducive to conducting electronic commerce. Many Web servers have been developed through which vendors can advertise and sell product. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming Web page to the client computer system and schedules shipment of the items.

Since the purchaser-specific order information contains sensitive information (e.g., a credit card number), both vendors and purchasers want to ensure the security of such information. Security is a concern because information transmitted over the Internet may pass through various intermediate computer systems on its way to its final destination. The information could be intercepted by an unscrupulous person at an intermediate system. To help ensure the security of the sensitive information, various encryption techniques are used when transmitting such information between a client computer system and a server computer system. Even though such encrypted information can be intercepted, because the information is encrypted, it is generally useless to the interceptor. Nevertheless, there is always a possibility that such sensitive information may be successfully decrypted by the interceptor. Therefore, it would be desirable to minimize the sensitive information transmitted when placing an order.

Presently, regardless of the site being used, there is no way to search the Internet to find a best price for a given product and, then, purchase the product with a single click. If such were possible, then significant improvements in speed of purchases, security of sensitive information, and reliability of purchases would exist.

### BRIEF DESCRIPTIONS OF THE DRAWINGS

For a more complete understanding of the present embodiment, and the advantages thereof, reference is now made to the following brief descriptions which are to be taken in conjunction with the accompanying FIGUREs, in which like reference numerals indicate like features.

FIG. 1 provides a view of the interaction between a user and the presently described method and system;

FIG. 2 provides a flow chart for the steps of the presently disclosed subject matter;

FIGS. 3 through 8 show screen displays associated with the operation of the presently disclosed method and system; and

FIGS. 9 through 12 provide exemplary source code listings for one embodiment of the presently disclosed subject matter.

### DETAILED DESCRIPTION OF THE FIGURES

The present disclosure describes a novel method and system for making automated purchases. Such purchases may be used using a cellular phone or other communications device, including a personal computer, and eliminates the need to provide user information. With the present disclosure, the user may search for a particular product across essentially all online merchants offering the desired product for sale.

Once the product has been identified, the user may purchase the product simply to clicking a “Buy Now” icon on the screen for the cellular phone or other communications device, including a personal computer.

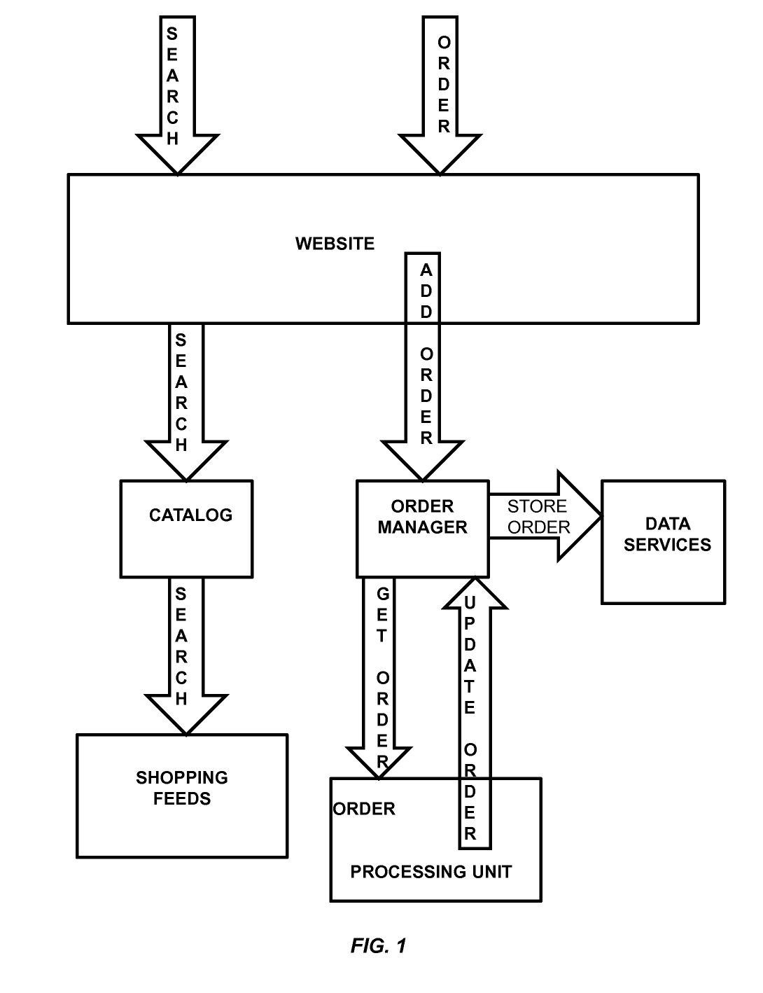

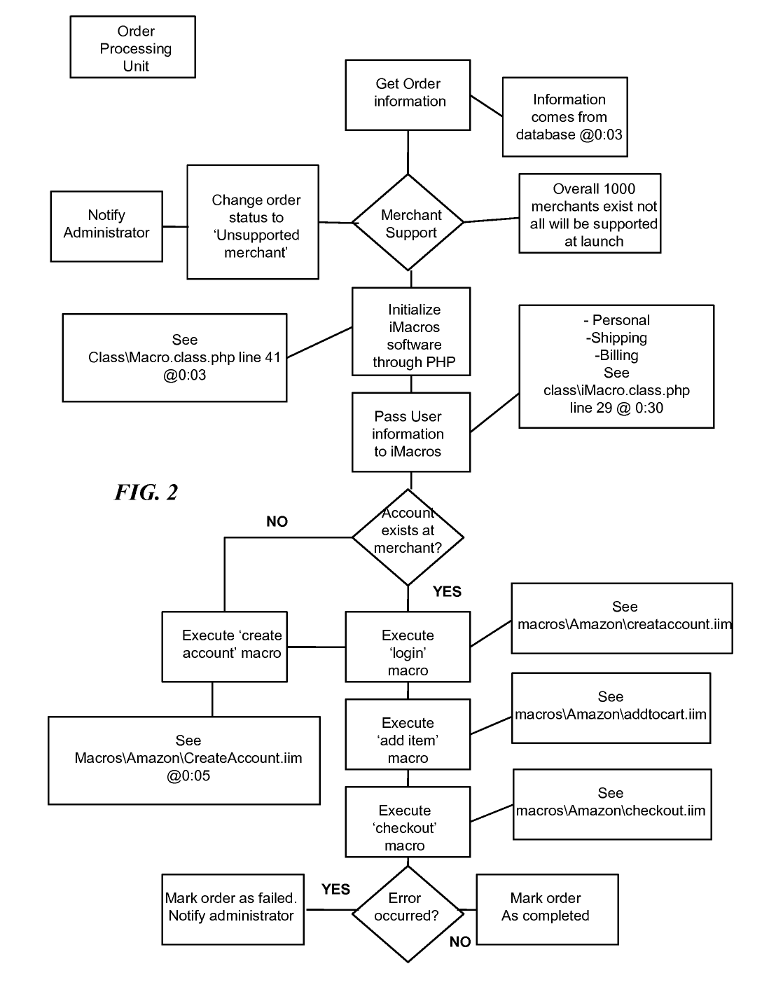

FIG. 1 shows how a user may interact with the system and process presently disclosed. FIG. 2 provides a functional flow diagram that depicts how the present system provides an “order processing unit” automatically processing an order. The flow chart of the order processing unit appearing in FIG. 2 describes how the present system links to source code and macros.

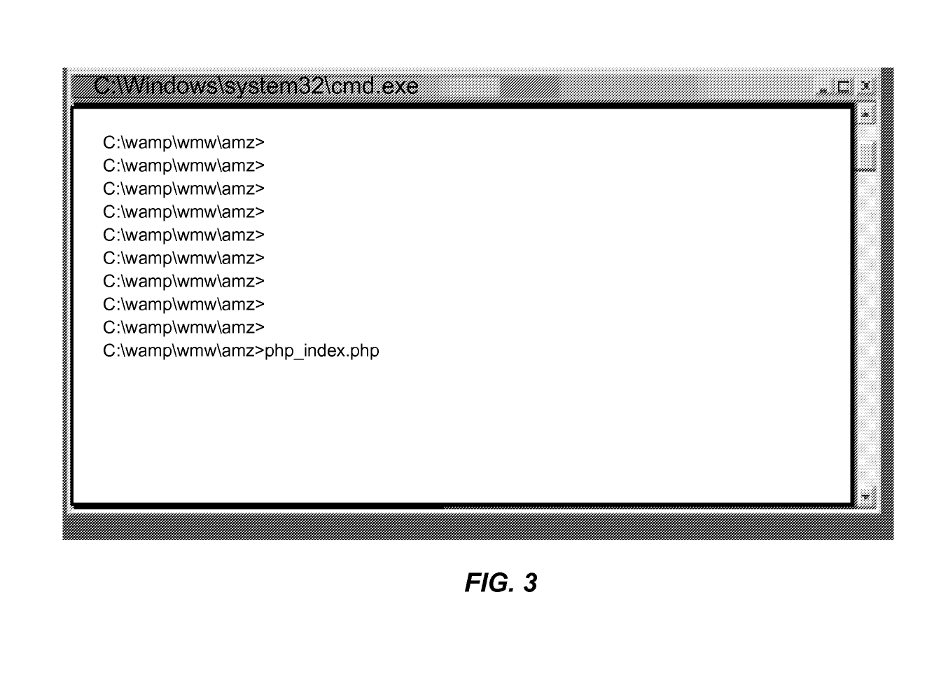

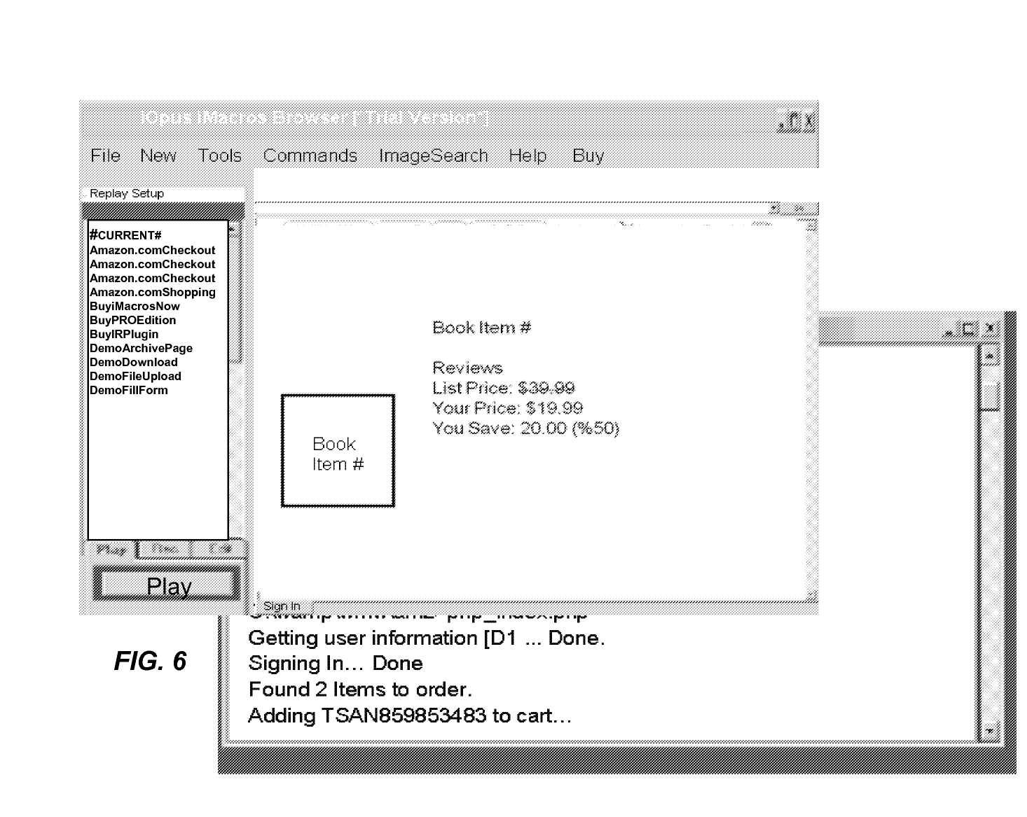

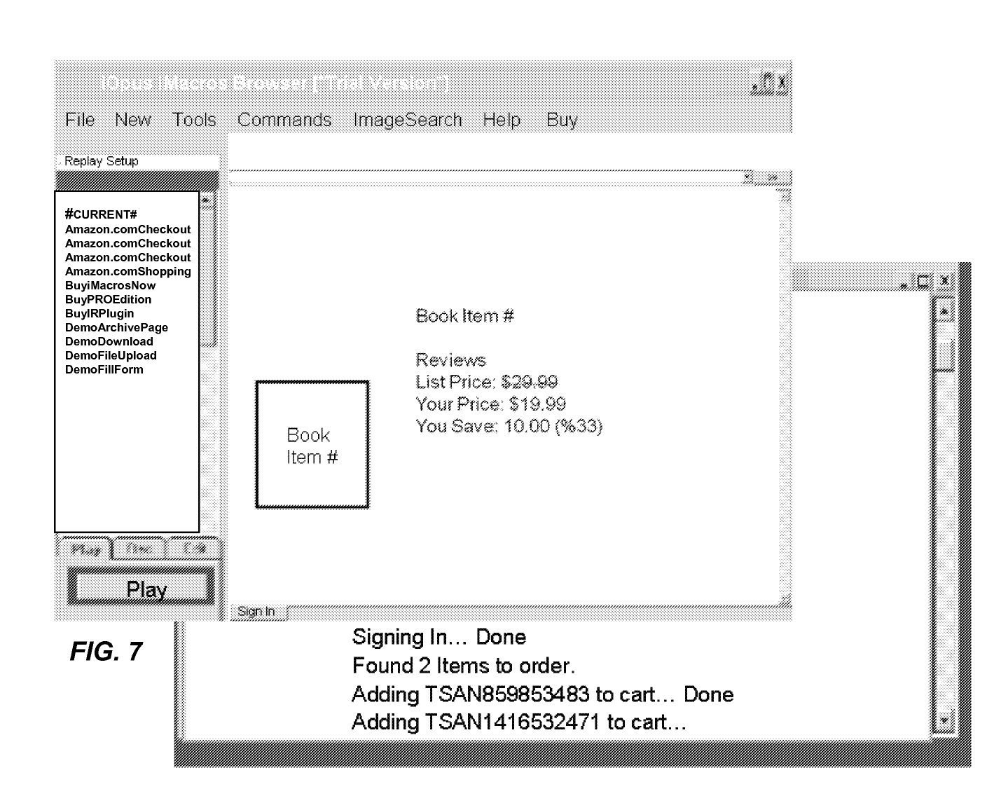

FIGS. 3 through 8 provide screen shots of a display presenting aspects of the disclosed system for backend operations, which operations may occur during use of the order processing unit. Note that a user interface for facilitating the operation of the present disclosure may take many forms. For example, a user may search for a product using a cellular phone, personal computer, or other communications device. From the search results, the user may identify the item he desires to purchase. By simply clicking on a “Buy Now” or similar icon on the cellular device or other communications device, including a personal computer, the user's information is obtained from a database and provided to the online merchant. The online merchant then may accept payment for the item automatically.

The search causes the present system to search a catalog for identifying different shopping sources or feeds, such as www.shopping.com and other sources. Once the user is satisfied with a selection, the user may purchase, bookmark, read reviews concerning or otherwise respond to the search results for the item he desires. By clicking on a “Buy Now” icon on the communications device, the user may purchase the desired item.

The order processing unit obtains needed information from a database and adds the needed information to the order information. The disclosed process takes the buy requests with the personal information of the user. The process saves the buy request, including information regarding the merchant, the price for the item, the time of the purchase decision, and other terms and information that relate to the buy decision.

Presently, over one thousand merchants offer products on the Internet, and the number is rapidly growing. The order processing unit determines if the merchant is supported by the present system. If the system does not already support a particular merchant, then the merchant is added manually to the script and may be accessed automatically the next time a user desires to connect with the particular merchant.

The order processing unit then initiates iMacro software through .php. for the use of a software macro allowing the integration of the user information and the order information. iMacro is a software program that provides the ability to perform automatically various ones of the individual steps of the presently disclosed method and system.

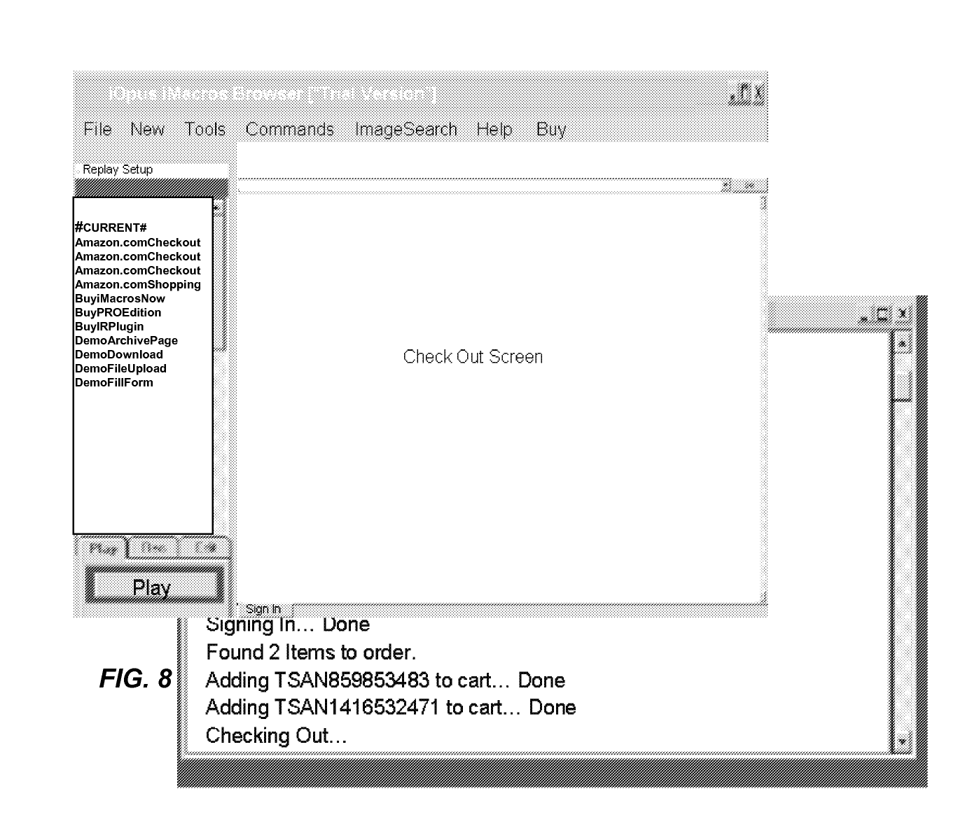

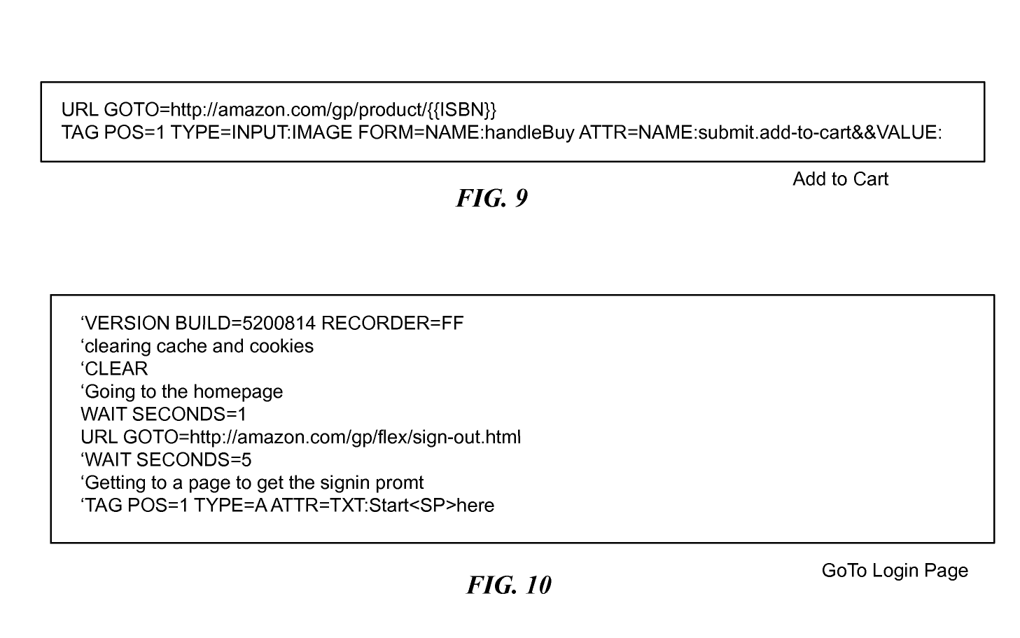

Then, the order processing unit passes the user information and order information from the proprietary database and software to the iMacros software, as shown in FIG. 3. The source code for performing this portion of the disclosed method and system appear in FIGS. 9 and 10.

If the user already has an account at www.amazon.com, for example, then we may simply execute the login macro on www.amazon.com, instead of creating a new user. If the user does not have an account, there is the need to create it first.

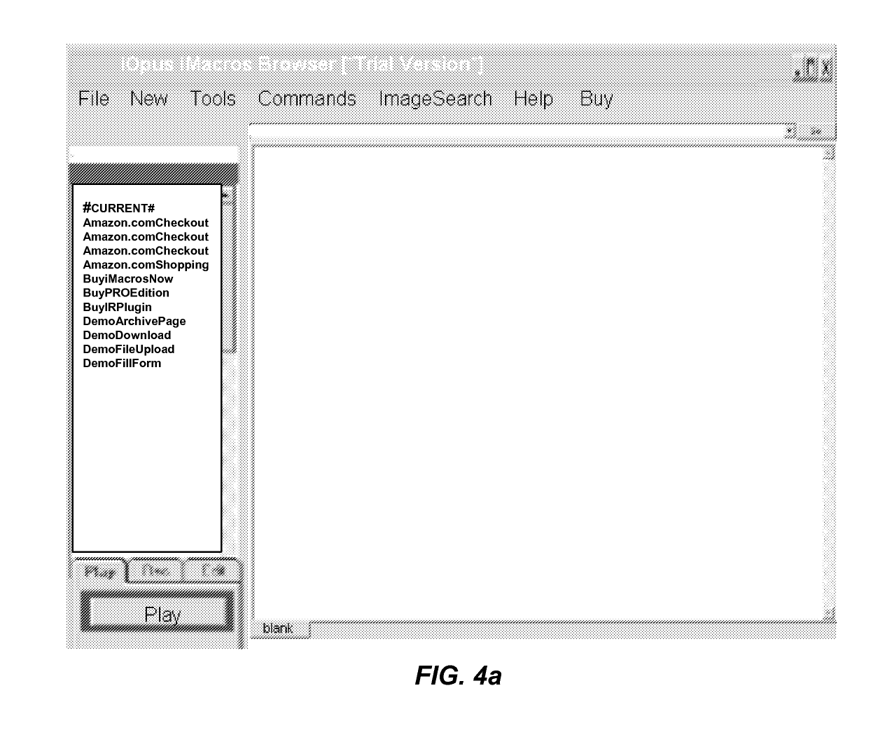

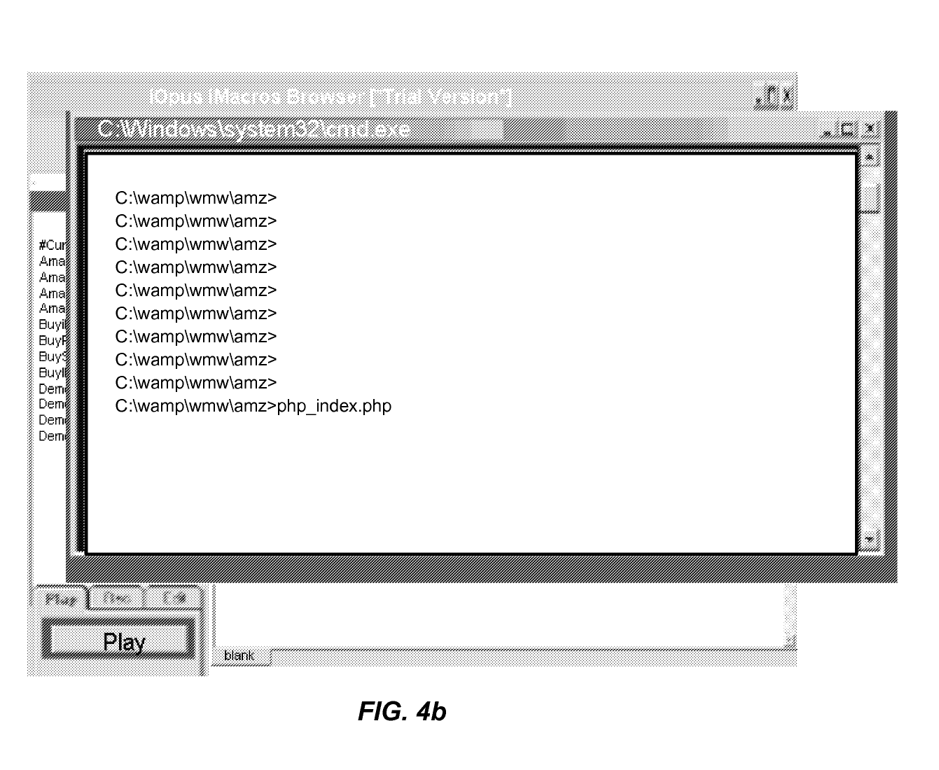

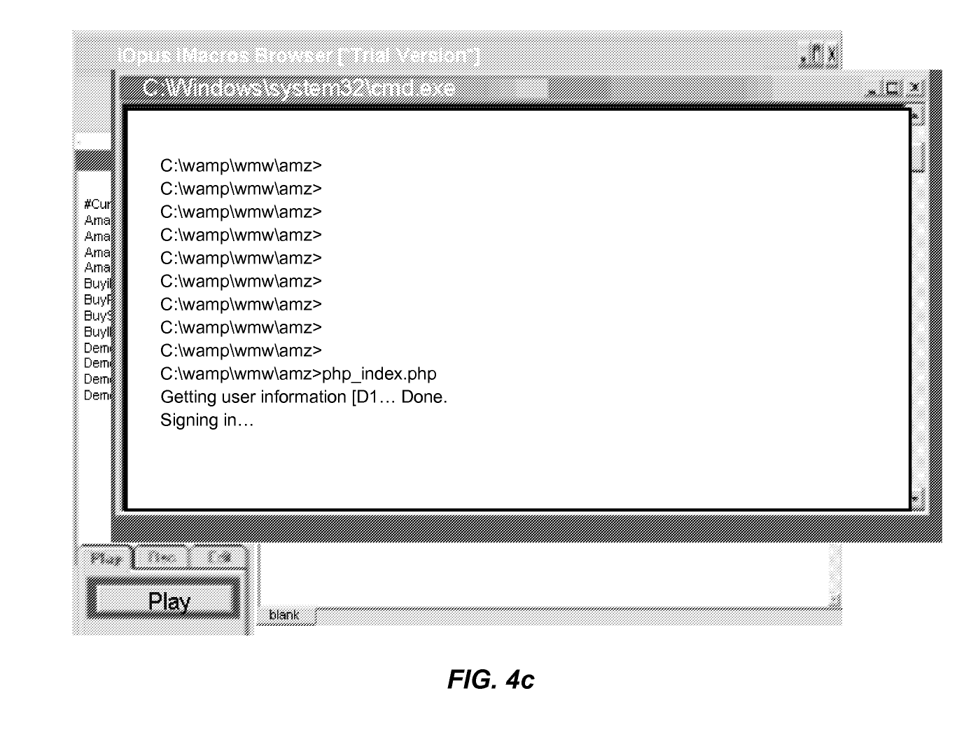

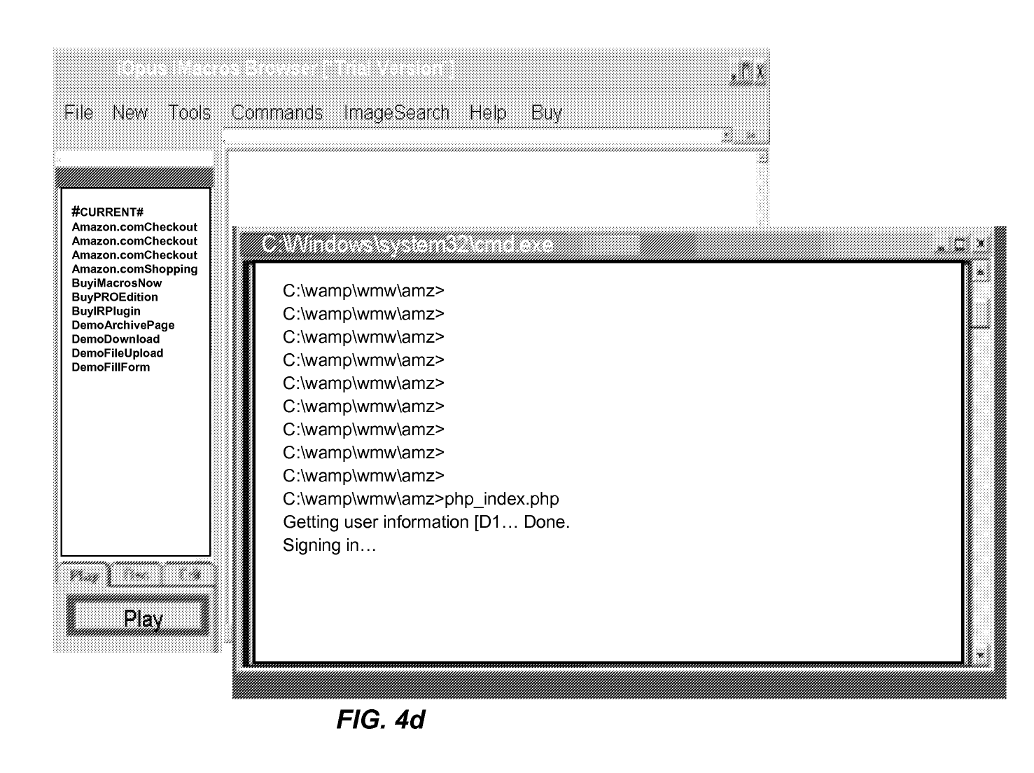

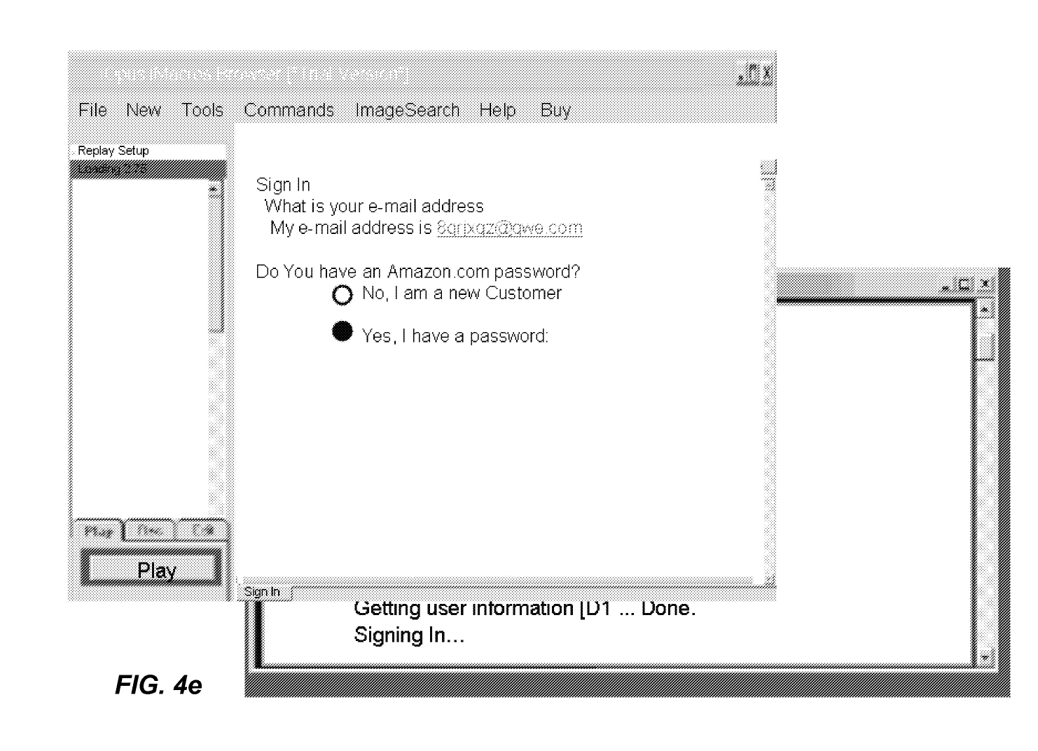

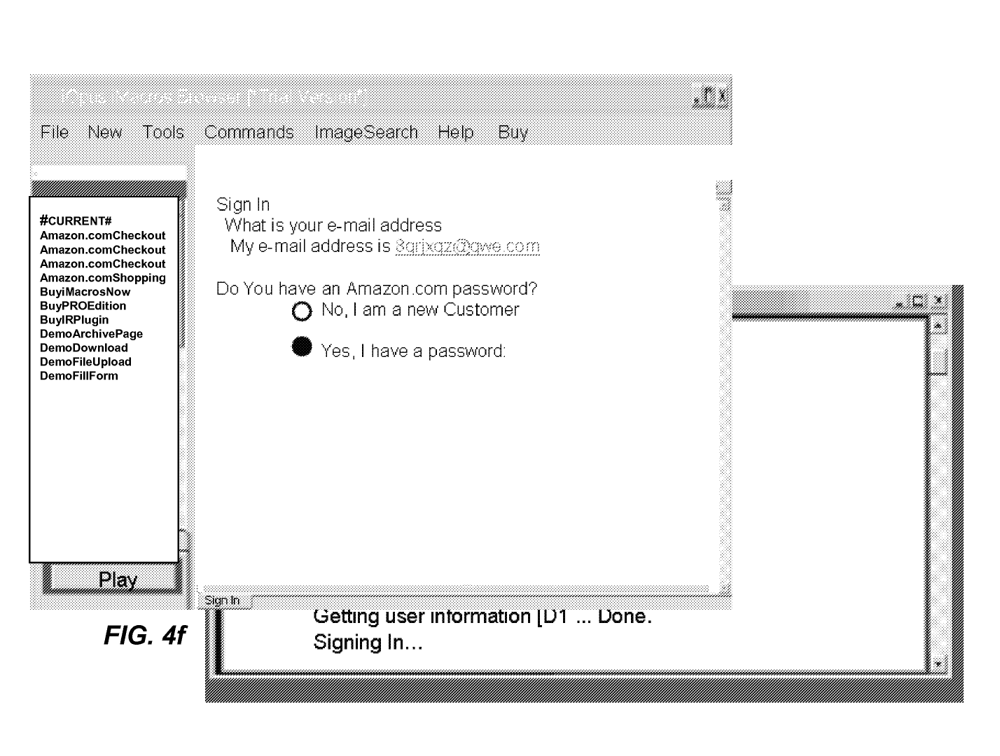

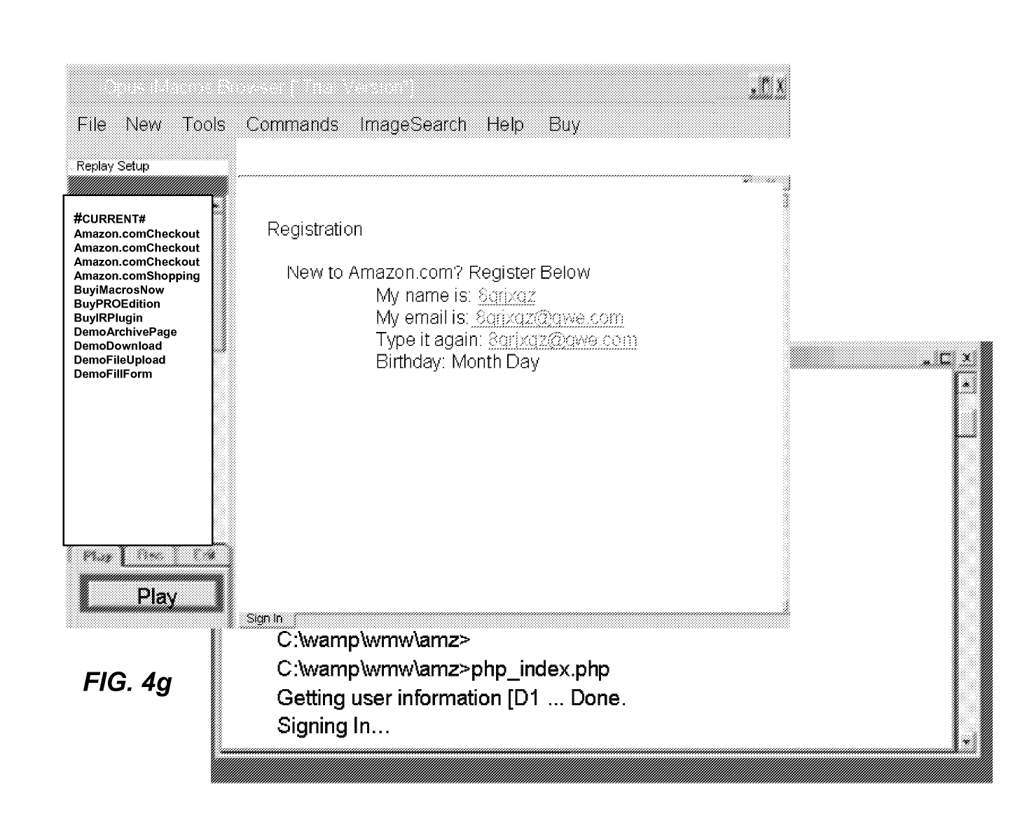

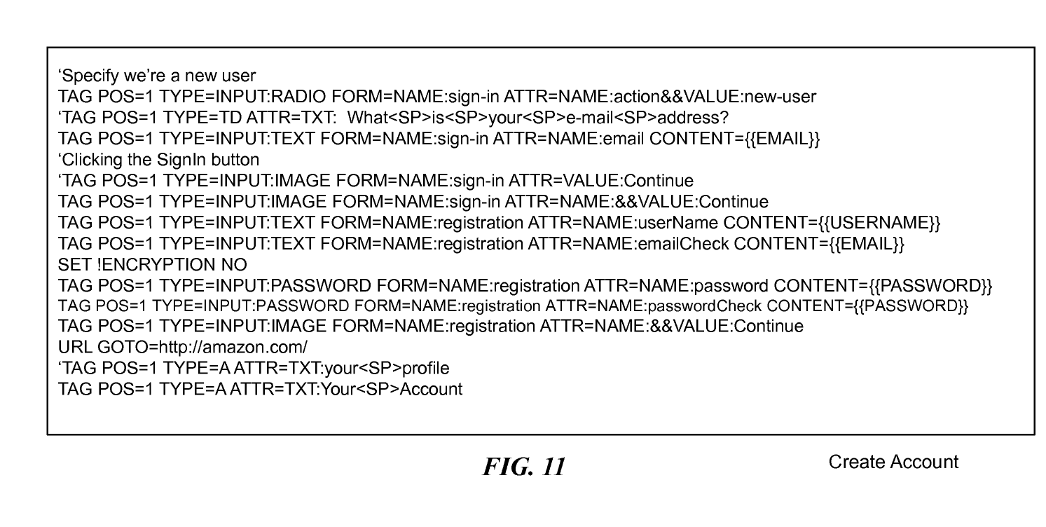

The account creation appears in FIGS. 4a through 4g. Source file that may create the needed user account appears in FIG. 11.

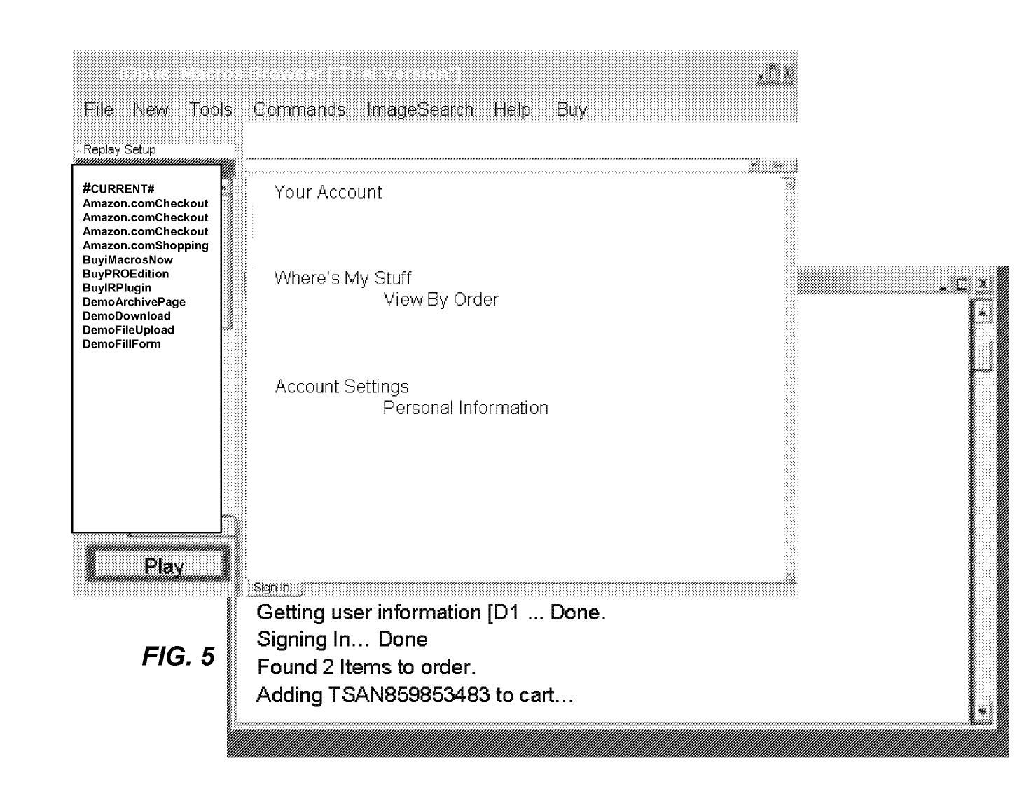

Once the account is created, we execute the “add item to cart” macro in the video. This occurs in FIGS. 5 through 7. This part of the process searches www.amazon.com for the item. Then, the process adds the item to the cart and confirms the need to add the item to the cart. This may occur, for example, in approximately 20 seconds.

After that, the order processing unit sends the information back to the database. This enables doing the transaction using the cell phone or any user device that browses on line. Once the account is created, the process allows for the user to provide the “one-click” buy on any merchant.

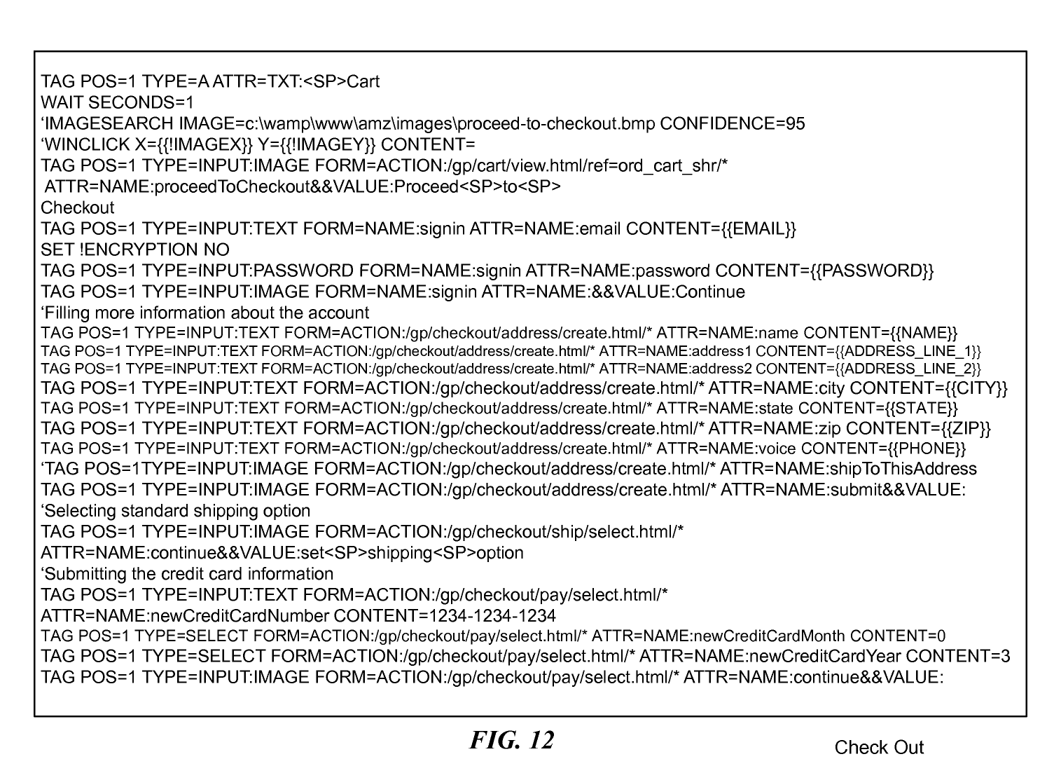

The process, therefore, has all of the desired information for the buy and passes that information on to any merchant from which the user desires to make a purchase. The source code for performing the checking out portion of the user's transaction appears in FIG. 12.

As a result of the presently disclosed subject matter, a user with a cell phone may buy product, essentially immediately after identifying the product. The presently disclosed system searches all available online sources and provide to the user the best price. If the user wants to buy the product, the user simply presses the “Buy Now” button and the purchase occurs.

A user may also perform the steps and achieve the results here disclosed using a UPC or EAN codes, which are ones of a wide variety of bar code languages called symbologies. The UPC is the barcode widely used in the United States and Canada for trade items in stores. In the UPC-A barcode, each digit is represented by a seven-bit sequence, encoded by a series of alternating bars and spaces. The UPC has only numerals, with no letters or other characters. In the barcode, each number is represented by two bar and space configurations. EAN was developed as a superset of UPC, adding an extra digit to the beginning so that there would be plenty of numbers for the entire world. There may be other codes for which use of the present disclosure may be feasible.

The system of the present disclosure serves an already logged in user, and makes the system available to user following the correct entry of a user password. The result is a system that provides the ability to place an order through the cell phone and personal computer that does not require a human to intervene to take the purchase.

The present system, therefore, makes the purchase automatically, without the need for human information. This reduces the costs for providing the service, increases the security in making purchases, and offers a more complete solution for the buyer. Because of the presently disclosed system an on-line purchase may occur from a website such as www.amazon.com, without the need for the user to www.amazon.com or similar websites to make purchases.

While the invention herein disclosed has been described by the specific embodiments and applications thereof, numerous modifications and variations could be made thereto by those skilled in the art without departing from the scope of the invention set forth in the claims.

While various embodiments of the present embodiment have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present embodiment should not be limited by any of the above-described exemplary embodiments, but should be defined only in accordance with the following claims and their equivalents.

Various software embodiments are described in terms of this example computer system. After reading this description, it will be apparent to a person skilled in the relevant art how to implement the invention using other computer systems and/or computer architectures.

What is claimed is:

1. A method of placing an order for an item comprising the steps of:
allowing a purchaser to search for an item, wherein said search is conducted across a plurality of merchants, wherein said merchants include merchants with and without a pre-existing agreement to be included in said search, wherein said search returns one or more of said merchants offering said item for sale; and
placing an order request for said item in response to only a single action being performed by the purchaser, wherein said order request includes identifying information for said item and previously stored purchaser specific order information.

2. The method of claim 1, wherein said purchaser may not have an account with said merchant.

3. The method of claim 2, including the additional step of verifying whether said purchaser has an existing account with said merchant, and if not, creating an account for said user at said merchant.

4. The method of claim 3, wherein said search results may be sorted by one or more of the following:
the lowest price including any shipping charges;
the lowest price including any shipping charges, taxes and fees;
the estimated transit time; and/or
the country of said merchant.

5. A system for placing an order for an item comprising:
a search component allowing a purchaser to search for an item, wherein said search is conducted across a plurality of merchants, wherein said merchants include merchants with and without a pre-existing agreement to be included in said search, wherein said search returns one or more of said merchants offering said item for sale; and
an order placing component for placing an order request for said item in response to only a single action being performed by the purchaser, wherein said order request includes identifying information for said item and previously stored purchaser specific order information.

6. The method of claim 5, wherein said purchaser may not have an account with said merchant.

7. The method of claim 6, including an account creation component that verifies whether said purchaser has an existing account with said merchant, and if not, creates an account for said user at said merchant.

8. The method of claim 7, wherein said search results may be sorted by one or more of the following:
the lowest price including any shipping charges;
the lowest price including any shipping charges, taxes and fees;
the estimated transit time; and/or
the country of said merchant.

9. A method of creating an account at a merchant comprising the steps of:
allowing a user to input a merchant or select a merchant from a list;
placing an account creation request in response to only a single action being performed by said user, wherein said account creation request includes previously stored user specific information;
inputting said account creation request at said merchant in a manner compatible with said merchant's new account creation form; and
submitting said new account creation form.

10. The method of claim 9, wherein said merchants include merchants with and without a pre-existing agreement to be included in said list.
